(19) United States
(12) Patent Application Publication
(10) Pub. No.: US 2008/0187131 A1
(43) Pub. Date: Aug. 7, 2008

(54) Adapter Connecting Telephone Signals to a Telephone to Adapt the Telephone for Use by a Child

(76) Inventor: Michael Brod, Florence (IT)

Correspondence Address: PATENT DOCKET CLERK;COWAN, LIEBOWITZ & LATMAN, P.C., 1133 AVENUE OF THE AMERICAS, NEW YORK, NY, 10036, US

(21) Appl. No.: 11/662,391

(22) PCT Filed: Sep. 9, 2005
(86) PCT No.: PCT/US2005/032443

§ 371 Date: Dec. 14, 2007

Related U.S. Application Data
(60) Provisional application No. 60/609,069, filed on Sep. 10, 2004.

(51) Int. Cl. H04M 1/00

(52) U.S. Cl. 379/442

(57) ABSTRACT

This invention includes an adaptor for use with a master-slave telephone system. In particular, the system comprises at least one slave telephone and a master control telephone for selectively controlling the application of telephone signals from a telephone line carrying the telephone signals. The adaptor of this invention comprises means for determining when the master controlling telephone is on hook and not in use, the adaptor disables the slave telephone. In particular, the determining means comprises a switch operative in a first state for connecting the telephone line to the slave telephone and in a second mode for disconnecting the telephone line from the slave telephone, and a sending means adapted to be connected to the slave telephone to sense the presence of a telephone signal passing along the telephone line and derived from the master control telephone, whereby upon sensing the presence of the telephone signal, said adaptor supplying the telephone signal is applied to the slave telephone.

### FIELD OF THE INVENTION

This invention relates to a master-slave telephone system, wherein the operation of a slave telephone is controlled by a master control telephone. In particular, this invention relates to such a master-slave system that is adapted for use with a child for educational/entertainment purposes.

### BACKGROUND

Many master-slave telephone systems have been created to cater to the communication needs of virtually every demographic age group with one notable exception. There are twenty-three million early communicators, age 6 and under, which cannot use the presently available technology to their maximum benefit. This invention seeks to create a master-slave system which is appropriate to serve this young population. Generally, this invention is adapted for use with a conventional phone when connected to the same telephone line, and enables a child and an adult to share in a conversation with a third party. The master-slave telephone system of this invention operates as a companion to a conventional telephone when connected to the same telephone line. As a result, the system of this invention permits a child and an adult to share in a conversation with a third party.

U.S. Pat. No. 5,267,306 of a Clay E. Hagan describes a dial controllable optionally operative device which is directly connected to the ring and tip lines of a subscriber loop. “On-hook” coupling is provided to allow the device to provide the conditional operation of one or more of the functional capabilities of a standard telephone. The device is useable in parallel with at least one standard telephone to provide a control telephone system. The Hagan device is also useable in an intercommunications system using the ring and tip lines of the subscriber loop. The Hagan patent requires the use of extra control methods, the use of a switch or touchtone keypad, or an additional control mechanism of hardware to enable or disable the slave unit. By contrast, the master-slave telephone system of this invention is completely automatic and transparent to the use of the controlling telephone and does not need a further switch to perform these functions.

### BRIEF DESCRIPTION OF THE DRAWINGS

This invention will be better understood when the following written description is considered in connection with the following set of drawings:

FIG. 1 is a schematic drawing of a first, illustrative embodiment of this invention, wherein the various elements of this invention are used in the same room;

FIG. 2 illustrates a second illustrative embodiment of this invention, wherein the various elements of the master-slave telephone system are disposed in different rooms of a typical home;

FIG. 3 illustrates a schematic of the first, illustrative embodiment of the master-slave telephone system of this invention; and

FIG. 4 illustrates a second embodiment of this invention by a schematic of the elements as incorporated into either of the embodiments shown in FIG. 1 or FIG. 2.

### SUMMARY OF THE INTENTION

This invention includes an adaptor for use with a master-slave telephone system. In particular, the system comprises at least one slave telephone and a master control telephone for selectively controlling the application of telephone signals from a telephone line carrying the telephone signals. The adaptor of this invention comprises means for determining when the master controlling telephone is on hook and not in use, the adaptor disables the slave telephone. In particular, the determining means comprises a switch operative in a first state for connecting the telephone line to the slave telephone and in a second mode for disconnecting the telephone line from the slave telephone, and a sending means adapted to be connected to the slave telephone to sense the presence of a telephone signal passing along the telephone line and derived from the master control telephone, whereby upon sensing the presence of the telephone signal, said adaptor supplying the telephone signal is applied to the slave telephone.

### DETAILED DESCRIPTION OF THE PREFERRED EMBODIMENTS OF THIS INVENTION

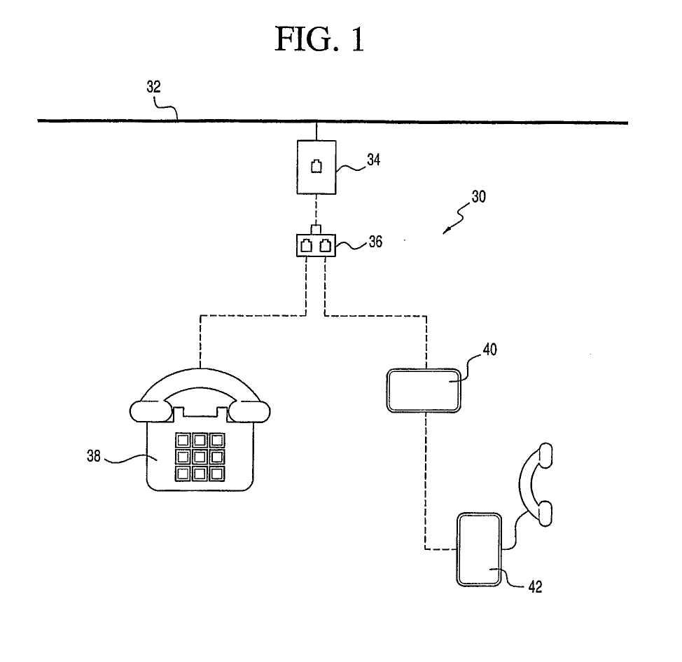

Referring now to the drawings and in particular to FIG. 1, there is shown a master-slave telephone system 30, which illustrates how a KidFone Adapter 40 and a KidFone Device 42 are connected in simple parallel to a controlling telephone unit 38 typically connected in the same room. This has the advantage of being able to use commonly available telephone extension hardware. In FIG. 1, an easily obtainable line-doubler jack 36 is used to make the connection. The system 30 includes the KidFone Adapter 40 and the Controlling Telephone Unit 38, which continues to operate normally if the KidFone Adapter 40 is removed or disabled.

A standard telephone is shown as the Controlling Telephone Unit 38. When the Controlling Telephone Unit 38 is off hook, and in use, the KidFone Adapter 40 enables the KidFone Device 42. When the Controlling Telephone Unit 38 is on hook and not in use, the KidFone Adapter 40 automatically disables the KidFone Device 42. No additional control buttons, switches or command functions are needed to enable and disable the KidFone Device 42. A standard, unmodified wired telephone set may be used as the Controlling Telephone Unit 38.

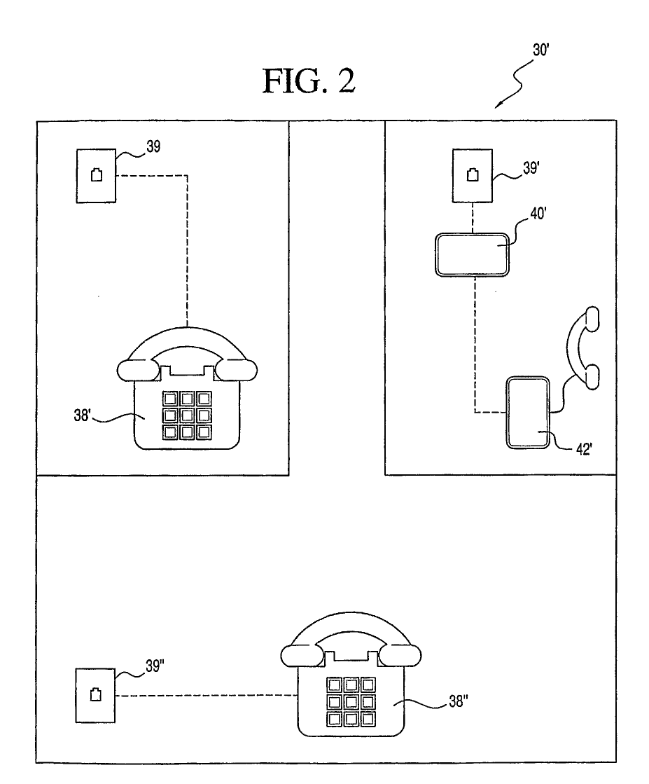

Referring now to FIG. 2, there is shown an alternative embodiment of the master-slave telephone system 30′ that illustrates that different rooms may use existing in-home phone line wiring how the KidFone Adapter 40′ and KidFone Device 42′, without the use of a line-doubler jack 36′, can be connected in different rooms of the house from the Controlling Telephone Unit 38′. The KidFone Adapter 40′ and KidFone 42′ operate exactly as described in the previous paragraph if they are connected to the same phone line 32′ as the Controlling Telephone Unit 38, but not necessarily in the same room and to the same jack 39′.

In operation, the KidFone external adapter 40′ is designed to provide automatic control of a limited use communication device, e.g., the KidFone Device 42, from the simple operation of a standard telephone set, e.g., unit 38′. A standard telephone is used as the controlling unit 38′. When the controlling unit 38′ is off hook, and in use, the limited use communication device 42′ is enabled. When the controlling unit 38′ is on hook, and not in use, the limited use communication device 42′ is disabled. No additional control buttons, switches or command functions are needed to enable and disable the limited use device 42′. A standard, unmodified wired telephone set may be used as the controlling unit 38′, reducing the cost to the customer of installing the system 30′.

The KidFone external adapter 40 is desired to be connected in simple parallel to the controlling unit 38, rather than in series. This has the advantage of being able to use commonly available telephone extension hardware, including an easily obtainable doubler jack 36. Another advantage is that the controlling telephone set 38 continues to operate normally if the adapter 40 is removed or disabled. If the adapter 40 is wired in series with a standard telephone set, this would require the cutting and splicing of wires by the user, and the restoration of the cut and splice when the adapter 40 was removed or disconnected, which is undesirable to require a consumer customer to modify the phone wiring in his house in order to use the adapter device 40.

In order to automatically control the limited use device 42 without any added switches, control buttons or command functions, the use of the controlling telephone set 38 must be determined from the signals present on the tip and ring of the phone line 32.

The standard telephone line 30 uses electrical signals in the following way: When the controlling telephone set 38 is on hook, idle, a negative DC voltage is present across the tip and ring lines, approximately −40VDC, and no current flows through the circuit, which is open. When the controlling telephone set 38 is in use, off hook, a current flows through the phone line circuit loop, approximately 20 ma to 50 ma, and the voltage across the line falls to approximately 10VDC, which is equal to the loop current forming a voltage across the impedance of the standard telephone set 38, which is normally 600 ohms. When the telephone set 38 is lifted off hook and allows the loop current to flow, this signals the equipment at the central office of the phone company that a new call is being initiated (then dial tone is generated), or a ringing line answered. When it is desired to end a phone call, placing the handset back on the hook of the controlling unit 38 stops the current flow and this signals the central office equipment that the phone call and the use of the KidFone device 42 is ended. Note that the line loop current is used for control, to initiate a new phone call, to answer a ringing line, and to end the call.

Since the KidFone external adapter 40 is connected in parallel, it cannot measure the loop current, it must derive it's function using the voltage change on the phone line 32 when the controlling unit 38 is off hook or on hook.

When the voltage on the tip and ring of the telephone line 32 corresponds to the controlling unit 38 being off hook (in use), the KidFone adapter 40 senses this voltage, and enables the limited use communication device 42 by performing two functions. Firstly, the adapter 40 begins sourcing loop current to activate the limited use device 42, which is sourced by a battery power supply. Second, the audio signals, which are the sound to and from the phone line 32 and to and from the KidFone device 42, are coupled to the telephone line 32. With the KidFone device 42 activated and the audio signals coupled together, the KidFone device 42 can be used for normal conversation.

Since the KidFone adapter 40 is connected in parallel and only couples the AC audio signals to the KidFone device 42, not the DC loop current, at no time does the KidFone device 42 have the ability to control the phone call, to hang up the active call, to initiate a new outgoing call, or to answer a ringing line. The above control is fixed. The controlling telephone unit 38 must be off hook for the KidFone device 42 to be used for conversation, and the controlling telephone alone can initiate an outgoing phone call, answer a ringing line, or hang up and end a call.

Since the KidFone adapter 40 performs its control function solely by sensing the voltage across the phone line 32, it is unnecessary to have additional switches, controls or buttons, operation is fully automatic and integral to using the controlling standard telephone 38 set in its normal way.

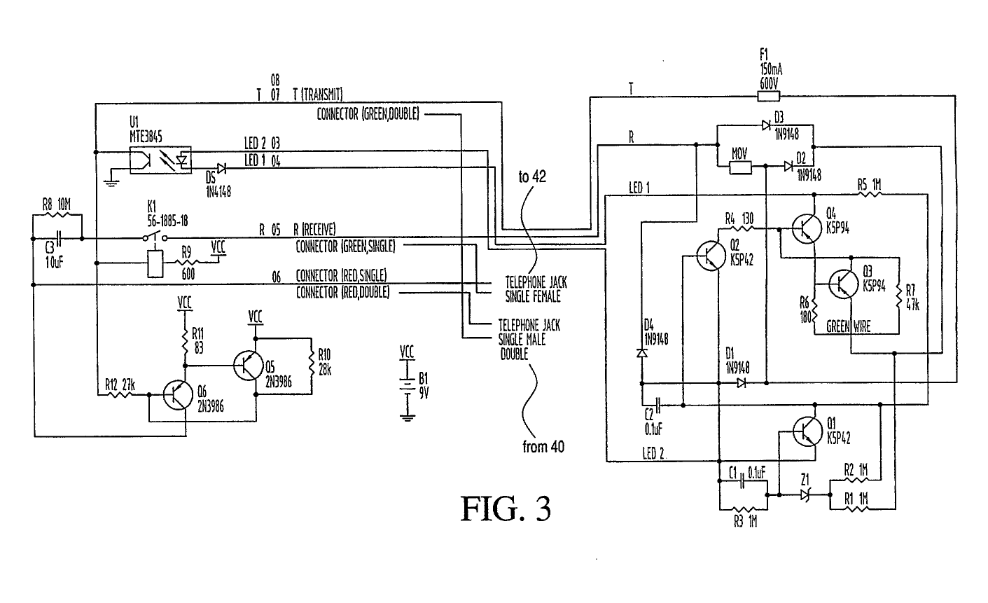

Referring now to the FIG. 3, there is shown a detailed description of an illustrated example of the KidFone external adapter 40. FIG. 3 schematic is a representative implementation of the principles of the invention of the external adapter 40. Other implementations, modifications of this circuit, and functional analogs may be incorporated into the system 30 as appreciated by one skilled in this art. This representative implementation is given to make concrete the description of the functions described herein.

The KidFone external adapter 40 is connected to a standard telephone line 32 in parallel to the controlling telephone unit 38 at connection point 1). This can easily use a standard off the shelf doubler plug 34, which splits the one socket of a telephone line jack into two, one for the controlling telephone unit 38, and one for the KidFone external adapter 40. The KidFone communication device 42 itself is connected to the adapter circuit 40 at connection point 2).

Being connected to a standard telephone line 32 means that the adapter circuit 40 is exposed to possible voltage surges on the telephone line 32 as a result of external events (lightning, high voltage wire crossing, etc). To protect the circuit 40 from these overvoltage spikes and surges, a surge suppressor 3) is present across the tip and ring of the phone line 32.

The sensing of the voltage level corresponding to the controlling telephone set 38 being on or off hook is set by the zener diode 4). The voltage rating of this zener diode is used to set a decision voltage threshold, at which this overall circuit 30 acts to enable or disable the KidFone communication device 42.

When the voltage threshold of the zener diode 4) is met, the transistor 5) is turned on, which allows current to be sourced to the anode of the LED in an optocoupler 8). Transistors 6) and 7) to complete the circuit of the LED in optocoupler 8) and allow current to flow through the LED, turning it on.

Circuit element 20) prevents too much current from flowing in the voltage sensing loop, which could load down the phone line 30 and prevent the controlling telephone unit 38 from ending the call by hanging up and breaking the current flow. Circuit diodes 21) prevent current from flowing the wrong way and damaging the adapter 40, in the case the adapter 40 is miswired to the phone line, which is unlikely using the standard doubler jack 36. Circuit device 22) prevents too much current from flowing in the LED circuit of optocoupler 8), preventing damaging it.

The function of the optocoupler 8) is to allow an isolated voltage (from the zener 4) and transistors 5),6),7) to control currents coming from the battery 12) which sources current and power to the KidFone device 42. The voltages of the phone line 32 are negative and below the potential the battery can normally provide. Therefore the negative voltages of the phone line 32 must be isolated so that the shift from the line voltages to the battery voltage may be made. The output of the optocoupler 8) is a transistor driver 9) (inside the optocoupler), which is turned on when the LED is on. An optocoupler 8) is a light controlled transistor switch. The LED creates the light, which turns on the output switch. The output side of optocoupler 8) is used to energize the coil of a small relay 10). The current through the relay coil 10) is limited by resistor 11).

The relay contacts 13) are used to connect the AC path of the audio signals from the telephone line 32 on port 1) to the KidFone device 42 on port 2). Since the phone line 32 and the KidFone device 42 are at widely different voltage potentials, the relay 10) is used to cleanly couple the AC audio signals and not cause any leakage currents from the phone line DC voltage. If the relay 10) was not present, the voltages of the phone line 32, including the high voltages of the ringing phone line signal (which are up to 90VAC) might leak over to the KidFone device 42.

The AC audio signals are connected in common between the phone line 32 and the KidFone device 42 but not the DC voltages, which are widely different. This is accomplished by capacitor device 14), which allows the AC audio signal voltages to pass but blocks the DC voltages and currents. Thus, when connected, via relay contacts 13), only the audio goes to the KidFone 42, not the DC voltage or phone line control current.

Since the KidFone device 42 itself needs a power supply and loop current to function when activated, the battery 12) must supply approximately 8 ma to 20 ma of loop current at 9VDC. It is required to limit the current and the power delivered to the controlled (KidFone) device 42, to prevent excessively large currents coming from the battery 12). The current limiting circuit of transistors 15) and 19), and the current limit is set by resistors 16), 17) and 18). Resistors 16) and 17) set the threshold of when to turn the current on. Resistor 18) determines the current limit itself. When the voltage drop across resistor 18) begins to exceed the 0.6V base to emitter voltage of transistor 19), transistor 19) begins to turn on, sourcing current through its collector, to the junction of the base of transistor 15) and resistor 16), which acts to turn transistor 15) off, thus limiting the current delivered by transistor 15) to the KidFone device 42. With the value of resistor 16) shown, for example, the current is limited to approximately 8 ma, which conserves battery life.

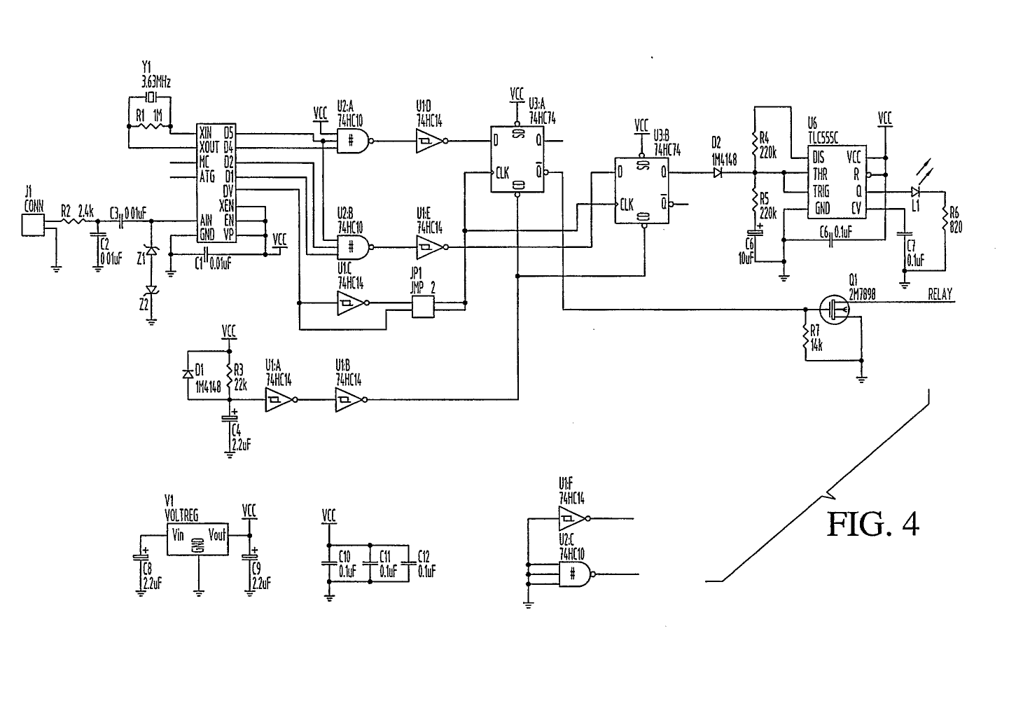

Referring now to FIG. 4, there is shown a further, second illustrative embodiment of this invention, wherein additional functionality is described. In operation, whenever the master control telephone is off-hook, the slave telephone is active and operational. When the “*” key is pushed on the master control telephone, the slave telephone will be a light with flash. Actuation of any other key except the “#” key on the keypad will cancel the beep and flash operation. Now, a child can use the slave telephone to converse not only with a first party, e.g., a parent, but also with a third party. When the “#” key is pushed on the master control telephone, the slave telephone will disconnect and the child will not be able to converse. Entering any other key except the “#” key will enable the phone for conversation.

Attached herewith is an Appendix, which includes a list of the part elements included within the schematic circuit of FIG. 3 and, in particular, identifies the particular element inserted therein, and further drawings illustrating as to how the adapter of this invention and the slave telephone may be incorporated in a single housing.

In the foregoing specification, the invention has been described with reference to specific embodiments. However, one of ordinary skill in the art appreciates that various modifications and changes can be made without departing from the scope of the present invention as set forth in the claim below. Accordingly, the specification and figures are to be regarded in an illustrative rather than a restrictive sense, and all such modifications are intended to be included within the scope of the present invention.

Benefits, other advantages, objects, and solutions to problems have been described above with regard to specific embodiments. However, the benefits, advantages, solutions to problems, objects, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

APPENDIX

| Qty | Ref | Description | Part Number |
|---|---|---|---|
| 1 | U2 | IC 74HC10 | TI SN74HC10N |
| 1 | U1 | IC 74HC14 | TI SN74HC14N |
| 1 | U3 | IC 74HC74 | TI SN74HC74N |
| 1 | U4 | IC 75T204 | TDK 75T204IP |
| 1 | U5 | IC TLC555C | TI TLC555CP |
| 1 | U6 | IC VOLTREG | Micro Chip MCP1701-5002I |
| 1 | U7 | OPTO NTE3045 | NTE 3045 |
| 1 | Q8 | Transistor 2N3904 | Fairchild 2N3904 |
| 2 | Q5 Q6 | Transistor 2N3906 | Fairchild 2N3906 |
| 1 | Q9 | Transistor 2N7000 | Supertex 2N7000N3 |
| 1 | Q7 | Transistor TP0604 | Supertex TP0604N3 |
| 2 | Q1 Q2 | Transistor KSP42 | Fairchild KSP42 |
| 2 | Q3 Q4 | Transistor KSP94 | Fairchild KSP94 |
| 1 | MOV | MOV 130 V | BC Components 2322 592 51316 |
| 1 | Z1 | Diode Zener 7.5 V 500 mW | ON 1N5236B |
| 2 | Z1 Z3 | Diode Zener 4.3 V 1 W 5% | ON 1N4731A |
| 5 | D1 D2 D3 | Diode 1N4004 | ON 1N4004 |
| | D4 D7 | | |
| 3 | D5 D6 D8 | Diode 1N4148 | 0N 1N4148 |
| 1 | L1 | LED | Lumex SSL-LX20R6SRD |
| 1 | C1 | Capacitor Cer 0.01uF 100 V | Panasonic ECU-S2A103KBA |
| 1 | C4 | Capacitor Poly 0.01uF 250 V | Panasonic ECQ-E2103KF |
| 6 | C6 C10-C14 | Capacitor Cer 0.1uF 50 V | Panasonic ECU-S1H104MEA |
| 1 | C2 | Capacitor Cer 0.1uF 100 V | Kemet C430C104M1U5CA7200 |
| 1 | C3 | Capacitor Cer 1uF 250 V | Panasonic ECQ-E2105KF |
| 2 | C8 C9 | Capacitor Tan 1uF 16 V | Panasonic ECS-F1CE105K |
| 2 | C5 C7 | Capacitor Tan 4.7uF 6.3 V | Panasonic ECS-F0JE475K |
| 1 | R11 | Resistor 82 Ohm ¼ W 5% | Panasonic ERD-S2TJ820V |
| 1 | R14 | Resistor 100 Ohm ¼ W 5% | Panasonic ERD-S2TJ101V |
| 1 | R4 | Resistor 130 Ohm ¼ W 5% | Panasonic ERD-S2TJ131V |
| 1 | R6 | Resistor 180 Ohm ¼ W 5% | Panasonic ERD-S2TJ181V |
| 1 | R20 | Resistor 680 Ohm ¼ W 5% | Panasonic ERD-S2TJ681V |
| 1 | R19 | Resistor 1.2K Ohm ¼ W 5% | Panasonic ERD-S2TJ122V |
| 2 | R16 R21 | Resistor 10K Ohm ¼ W 5% | Panasonic ERD-S2TJ103V |
| 1 | R15 | Resistor 22K Ohm ¼ W 5% | Panasonic ERD-S2TJ223V |
| 1 | R12 | Resistor 27K Ohm ¼ W 5% | Panasonic ERD-S2TJ273V |
| 1 | R7 | Resistor 47K Ohm ¼ W 5% | Panasonic ERD-S2TJ473V |
| 2 | R17 R18 | Resistor 220K Ohm ¼ W 5% | Panasonic ERD-S2TJ224V |
| 1 | R10 | Resistor 270K Ohm ¼ W 5% | Panasonic ERD-S2TJ274V |
| 5 | R1 R2 R3 | Resistor 1M Ohm ¼ W 5% | Panasonic ERD-S2TJ105V |
| | R5 R14 | | |
| 1 | R8 | Resistor 10M Ohm ¼ W 5% | Panasonic ERD-S2TJ106V |
| 1 | K1 | Relay Reed | Coto 9081-05-00 |
| 1 | Y1 | Crystal 3.5795 MHz | ECS ECS-35-17-1 |
| 1 | F1 | Fuse | Raychem TR600-150 |
| 1 | JP | Header 3 Pin | Molex 22-28-4033 |
| 1 | XJP | Shorting Plug | AMP 382811-8 |
| 1 | XB1 | 9 V BAT Clip 6″ | Keystone 233 |
| 1 | B1 | 9 V BAT | Energizer EN22 |
| 1 | SPK | Beeper | CUI CEP-2242 |

I claim:

1. An adaptor for use with a master-slave telephone system, wherein the system comprises at least one slave telephone and a master control telephone for selectively controlling the application of telephone signals from a telephone line carrying the telephone signals, said adaptor comprising:
a) means for determining when the master controlling telephone is on hook and not in use, said adaptor disables the slave telephone; and
b) said determining means comprises a switch operative in a first state for connecting the telephone line to the slave telephone and in a second mode for disconnecting the telephone line from the slave telephone, and a sending means adapted to be connected to the slave telephone to sense the presence of a telephone signal passing along the telephone line and derived from the master control telephone, whereby upon sensing the presence of the telephone signal, said adaptor supplying the telephone signal is applied to the slave telephone.
